(19) United States
(12) Patent Application Publication
(10) Pub. No.: US 2026/0085020 A1
(43) Pub. Date: Mar. 26, 2026

(54) SOIL AMENDMENT SYSTEM AND METHOD

(71) Applicant: Sarah Burnett Truesdell, Idalou, TX (US)

(72) Inventor: Sarah Burnett Truesdell, Idalou, TX (US)

(21) Appl. No.: 19/109,551

(22) PCT Filed: Sep. 6, 2023
(86) PCT No.: PCT/US2023/032100

§ 371 Date: Mar. 6, 2025

Related U.S. Application Data
(60) Provisional application No. 63/374,742, filed on Sep. 6, 2022.

(51) Int. Cl. C05F 11/08; C05F 5/00; C05G 3/80; C05G 5/14

(52) U.S. Cl. CPC C05F 11/08; C05F 5/002; C05G 3/80; C05G 5/14

(57) ABSTRACT

In some aspects, a soil amendment includes abase material and a microbial material incorporated into the base material. In some aspects, the soil amendment further includes one or more of an activator and/or a mineral that is incorporated into the base material. In some aspects, a method of making a soil amendment includes preparing a base material; adding a microbial material to the base material; and mixing the base material and the microbial material together. In some aspects, a method of using the soil amendment of claim 1 includes adding a soil amendment to a soil, the soil amendment comprising a base material and a microbial material incorporated into the base material.

### CROSS-REFERENCE TO RELATED APPLICATIONS

This patent application claims priority from, and incorporates by reference the entire disclosure of, U.S. Provision Application No. 63/374,742 filed on Sep. 6, 2023.

### TECHNICAL FIELD

The present disclosure relates generally to soil enhancement products and more particularly, but not by way of limitation, to a soil amendment system and method that improves soil conditions at the rhizosphere level.

### BACKGROUND

This section provides background information to facilitate a better understanding of the various aspects of the disclosure. It should be understood that the statements in this section of this document are to be read in this light, and not as admissions of prior art.

Farmers across arid regions throughout the world face a perfect storm with consistent periods of drought, urban pressures on vital water resources, and economic hurdles. While climatic conditions create a barrier to production, farmers face rising fuel and input costs alongside growing inflation rates. These factors lead to more intensive and sometimes destructive farming practices that limit the soil's ability to store water and life. Some farmers turn to alternative practices such as no-till, cover cropping, and other regenerative techniques to counter these pressures and limitations. These practices have proven to improve soil health and water-holding capacity over time. While there is growth in the adoption of these practices, arid regions face challenges in transitioning due to: uniquely hot and dry conditions; financial risk associated with the conversion and implementation of new practices; limited access to regenerative soil amendments.

Regenerative practices can change the composition and overall health of the soil, but these practices are not an immediate or universally applicable solution for farmers. Smaller-scale gardeners and landscapers have turned to peat moss for immediate improvement of water retention and soil health. While peat moss does provide immediate soil amendments, it is a nonrenewable resource, and its removal and exportation to other countries disrupt carbon sequestration in bog ecosystems. Furthermore, given the composition and cost of peat moss, there is no efficient or economical way to apply peat moss in traditional commercial agriculture.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In some aspects, a soil amendment includes a base material and a microbial material incorporated into the base material. In some aspects, the soil amendment further includes one or more of an activator and/or a mineral that is incorporated into the base material.

In some aspects, the base material comprises cotton seed meal and the microbial material is selected from the group consisting of Acetobacter lovaniensis, Bacillus sp, Bacillus Megaterium, Psedudomonas, Rhizobium, Enterobacter cloacae, Saccharomyces cerevisiae, Pichia, and Galactomyces sp.

In some aspects, the activator is a viscous liquid mineral, but could be any of a variety of viscous fluids that help bind microbial and/or minerals to the base material.

In some aspects the minerals are selected from the group consisting of hydrogen, boron, silicon dioxide, carbon, nickel, cobalt, and copper.

In some aspects, the soil amendment further includes an activator incorporated into the base material and at least one mineral incorporated into the base material, wherein the microbial material is selected from the group consisting of Acetobacter lovaniensis, Bacillus sp, Bacillus Megaterium, Psedudomonas, Rhizobium, Enterobacter cloacae, Saccharomyces cerevisiae, Pichia, and Galactomyces sp, wherein the activator is a viscous liquid mineral, but could be any of a variety of viscous fluids that help bind microbial and/or minerals to the base material (e.g., maple syrup, nectar from a fruit, and the like) and wherein the minerals are selected from the group consisting of hydrogen, boron, silicon dioxide, carbon, nickel, cobalt, and copper.

In some aspects, the soil amendment further includes an activator incorporated into the base material and at least one mineral incorporated into the base material, wherein the soil amendment comprises between 90-98% base material, between 1-3% activator, between 1-5% microbial material, and between 1-3% mineral.

In some aspects, a method of making a soil amendment includes preparing a base material; adding a microbial material to the base material; and mixing the base material and the microbial material together.

In some aspects, the preparing comprises forming the base material into a plurality of pellets. In some aspects, the preparing comprises forming the base material into a loose form.

In some aspects, the base material comprises cotton seed meal.

In some aspects, the microbial material is selected from the group consisting of Acetobacter lovaniensis, Bacillus sp, Bacillus Megaterium, Psedudomonas, Rhizobium, Enterobacter cloacae, Saccharomyces cerevisiae, Pichia, and Galactomyces sp.

In some aspects, the adding a microbial material comprises adding two or more different microbial materials.

In some aspects, the method further comprises adding an activator to the base material.

In some aspects, the activator is selected from the group consisting of a viscous liquid mineral, maple syrup, and nectar from a fruit.

In some aspects, the method further comprises adding a mineral to the base material.

In some aspects, the mineral is selected from the group consisting of hydrogen, boron, silicon dioxide, carbon, nickel, cobalt, and copper.

In some aspects, the method further comprises adding an activator and at least one material into the base material, wherein the soil amendment comprises between 90-98% base material, between 1-3% activator, between 1-5% microbial material, and between 1-3% mineral.

In some aspects, a method of using the soil amendment of claim 1 includes adding a soil amendment to a soil, the soil amendment comprising a base material and a microbial material incorporated into the base material.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

Drought stress and water scarcity adversely affect the quality and condition of the soil. Farmer resilience depends on water effectively being stored in the soil, enabling microbial communities to thrive. Supporting soil health during dry growing seasons decreases overall energy and water consumption, increasing farmer profitability during water-deficient periods. The need for immediate water-holding capacity improvement in arid soils presents a timely opportunity to deliver a cheaper, natural alternative to peat moss that addresses the growing need to improve water-holding capacity upon application. In semi-arid farmlands, soil health is limited by naturally low levels of organic matter, insufficient moisture, and decreased microbial activity. As a result, soils are typically alkaline, which decreases nutrient availability to the plants, even when nutrients are present in the soil. Healthy soils impact the entire community by providing regenerative ecosystems that improve air quality, sequester greenhouse gasses, and recharge water tables.

The present disclosure provides a system and method of enhancing the rhizosphere (soil zone that surrounds plant roots) via a soil amendment that addresses one or more of microbiological, hydration, and mineral aspects of the soil. Healthy soil is comprised of organic matter, microbiological organisms, inorganic mineral particles, plant nutrients, and water. When any of these components are missing, the soil is compromised and will no longer function at its peak as a healthy growing medium. The soil amendment described herein is a natural, sustainable, scalable solution that is affordable, and, compared to conventional products, the disclosed system and method provide a superior soil amendment that stimulates biological functions, encourages beneficial microbial activities, and greatly improves water retention in the soil.

In various aspects, the soil amendment includes a base material that may be, for example, a natural cotton byproduct that is sustainably sourced and highly scalable, making it a perfect alternative to peat moss. By way of example, whole fuzzy cottonseed, a byproduct of cotton, may be used to form the base material. Whole fuzzy cottonseed has excellent water retention properties and is full of nutrients, energy, protein, and fiber, which provide various benefits to the rhizosphere. Benefits include creating soil environments in which microbes can thrive. In other aspects, other natural or synthetic materials may be used. Generally speaking, the base material may be selected from a variety of materials, with a primary aspect of the base material being its ability to absorb water. Additional natural materials include wood-based byproducts, coconut coir, peat moss, compost, perlite, vermiculite, and the like. Synthetic materials include super absorbent polymers, such as, synthetic acrylic polyacrylamide and the like.

In general, the base material is chosen to increase a water-holding capacity of the soil. The water-holding capacity of the soil is important for plant hydration, but is also critical as soil hydration also stimulates biological functions and encourages beneficial microbial activities within the soil. Microbial activity plays an important role in plant health and growth. Increasing water retention also increases the overall profitability of farmers during water-deficient periods as less water needs to be applied to the soil. In testing, water usage has been decreased by as much as 50% compared to soil that did not incorporate the soil amendments disclosed herein. Decreasing water usage can dramatically reduce water costs. Table 1 below demonstrates the significant cost savings made possible by incorporating the soil amendments disclosed herein.

TABLE 1
Water cost benefit comparison by using soil amendment

| | Avg Water | Avg Cost | Total | Total for |
|---|---|---|---|---|
| | Demand | Per Inch to | Per Acre to | a 120 |
| Crop | per Season | Irrigate Crop | Irrigate Crop | Acre Field |
| Cotton | 16″ | $9.50 | $9,120.00 | $23,040.00 |
| Cotton w/soil | 16″ | $4.47 | $5,760.00 | $11,520.00 |
| amendment | | | | |

The soil amendments disclosed herein will: retain more water in the soil profile throughout the growing season; better manage soil health during dry growing seasons; add beneficial organic matter to depleted soils (important for overall rhizosphere health/microbial activity); decrease water usage by up to 20-35% (and up to 50% in certain conditions), which minimizes energy consumption (e.g., less pumping and maintenance needed); and increase carbon sequestration potential as a result of better crop and soil function. Decreases in water usage can also be beneficial to maintaining aquifer levels, especially in times of drought.

Reference will now be made to particular materials and methods utilized by various embodiments of the present disclosure. However, it should be noted that the materials and methods presented below is for illustrative purposes only and is not intended to limit the scope of the claimed subject matter in any way.

In an exemplary aspect, the system includes a base material, a microbial material, and one or more minerals. In some aspects, the system also includes an activator material that helps adhere the microbial and/or minerals to the base material. The base material is selected to absorb and retain water. Water retention is important for plant hydration, but is also important for microbial activation. Without sufficient soil moisture, the microbes will revert to their spore form and will not provide benefits to the rhizosphere.

The base material may be made from, for example, whole fuzzy cottonseed. The whole fuzzy cottonseed may be processed into a meal or a pellet form. In the meal form, the material has a stuffing like consistency. The meal form may be easily incorporated into soil by simply adding the meal to soil and mixing. In the pellet form, the meal is compressed into small pellets. In some aspects a binder may be used to help the material retain its pellet form. Compared to the meal form, the pellet form is denser. In some aspects, the pellets may be cylindrical with a diameter of between about 1-5 mm and a length of between about 1-10 mm. It will be appreciated that the pellets can be formed into a variety of shapes and sizes as desired. In some aspects, the pellet form is particularly suited for commercial agricultural use as it can be easily spread using spreaders and other farming equipment.

The microbial material is selected to enhance the rhizosphere. In some aspects, the microbial material is an organic soil amendment that may include, for example, Leonardite, sucrose, Bacillus firmus, Bacillus thuringensis, Ascomycota spp., Acetobacter lovaniensis, Bacillus sp, Bacillus Megaterium, Psedudomonas, Rhizobium, Enterobacter cloacae, Saccharomyces cerevisiae, Pichia, and/or Galactomyces sp. Benefits of adding microbial material includes introducing enzymes, such as amylases and proteases. Additional benefits include controlling root-knot nematodes and providing environmentally friendly insecticide benefits.

The minerals are selected to enhance the nutrients in the soil to promote plant growth. The minerals may be, for example, hydrogen, boron, silicon dioxide, carbon, nickel, cobalt, or copper. In some aspects, one or more of alumina (Al₂O₃), barium oxide (BaO), calcium oxide (CaO), carbon (C), chlorine (Cl), ferric oxide (Fe₂O₃), hydrogen (H), magnesium oxide (MgO), manganese oxide (MnO₂), Nitrogen (N), oxygen (O), phosphorous pentoxide (P₂O₅), potassium oxide (K₂O), silicon dioxide (SiO₂), sodium oxide (Na₂O), strontium oxide (SrO), and titanium dioxide (TiO₂). In some aspects, one mineral is incorporated into the soil amendment. In some aspects, two or more minerals are incorporated into the soil amendment.

In various aspects, an activator may be used to help retain the microbial material and/or the minerals. In some aspects, the activator is an organic liquid mineral derivative with a semi-sticky texture allowing the microbes and minerals to adhere to the base material. In general, the activator may be selected from a variety of materials, with a primary aspect of the activator material being its ability to bind/retain the microbial material with the base material. The activator may be any substance that is viscous and will help bind the microbial material and minerals to the base material. For example, the activator may be a viscous liquid mineral and the like. In some aspects, the viscous liquid mineral comprises an organic form of silica that is absorbable by plant roots.

In some aspects, the soil amendment comprises between about 90-98% base material, between about 0-3% activator, between about 1-5% microbial material, and between about 1-3% mineral. It will be appreciated that these values can be increased or decreased depending on the application.

A method of making an enhanced soil amendment includes preparing a base material. The base material may be made from whole fuzzy cottonseed and formed into a meal or a plurality of pellets. After the base material is prepared, the activator (if used), microbial material, and minerals may be added in the desired amounts to the base material. The base material, activator (if used), microbial material, and minerals may then be worked or blended together until thoroughly incorporated. The enhanced soil amendment is then ready for use.

A method of using the enhanced soil amendment includes adding the enhanced soil amendment to soil. In meal form, the soil amendment may be mixed into loose soil, proximal to where the root system of a plant will be. In some aspects, about one cup of enhanced soil amendment will treat about twelve one-pint containers, six one quart containers, or one one gallon container. In some aspects, more or less enhanced soil amendment may be added to the soil. After the enhanced soil amendment has been added to the soil, the combination may be mixed together to distribute the enhanced soil amendment throughout the soil. The treated soil may then be watered as usual. In pellet form, the soil amendment may be loaded into a spreader or other equipment used to distribute pelletized and/or seed-type materials. The pellets may then be worked into the soil. The soil may then be watered as usual.

The enhanced soil amendments disclosed herein are capable of retaining over 300% more water than soil alone (as much as 328% more in testing), provides beneficial microbes that improve soil health, increases organic matter in the soil that improves plant growth, and increases beneficial mineral content in the soil that also improves plant growth.

Although various embodiments of the present disclosure have been described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A soil amendment comprising:
a base material; and
a microbial material incorporated into the base material.

2. The soil amendment of claim 1, further comprising an activator incorporated into the base material.

3. The soil amendment of claim 1, further comprising at least one mineral incorporated into the base material.

4. The soil amendment of claim 1, wherein the base material comprises cotton seed meal and the microbial material is selected from the group consisting of Acetobacter lovaniensis, Bacillus sp, Bacillus Megaterium, Psedudomonas, Rhizobium, Enterobacter cloacae, Saccharomyces cerevisiae, Pichia, and Galactomyces sp.

5. The soil amendment of claim 2, wherein the activator is a viscous liquid mineral.

6. The soil amendment of claim 3, wherein the minerals are selected from the group consisting of hydrogen, boron, silicon dioxide, carbon, nickel, cobalt, and copper.

7. The soil amendment of claim 1, further comprising:
an activator incorporated into the base material and at least one mineral incorporated into the base material,
wherein the microbial material is selected from the group consisting of Acetobacter lovaniensis, Bacillus sp, Bacillus Megaterium, Psedudomonas, Rhizobium, Enterobacter cloacae, Saccharomyces cerevisiae, Pichia, and Galactomyces sp,
wherein the activator is a viscous liquid mineral, and
wherein the minerals are selected from the group consisting of hydrogen, boron, silicon dioxide, carbon, nickel, cobalt, and copper.

8. The soil amendment of claim 1, further comprising:
an activator incorporated into the base material and at least one mineral incorporated into the base material,
wherein the soil amendment comprises between 90-98% base material, between 1-3% activator, between 1-5% microbial material, and between 1-3% mineral.

9. A method of making a soil amendment, the method comprising:
preparing a base material;
adding a microbial material to the base material; and
mixing the base material and the microbial material together.

10. The method of claim 9, wherein the preparing comprises forming the base material into a plurality of pellets.

11. The method of claim 9, wherein the preparing comprises forming the base material into a loose form.

12. The method of claim 9, wherein the base material comprises cotton seed meal.

13. The method of claim 9, wherein the microbial material is selected from the group consisting of Acetobacter lovaniensis, Bacillus sp, Bacillus Megaterium, Psedudomonas, Rhizobium, Enterobacter cloacae, Saccharomyces cerevisiae, Pichia, and Galactomyces sp.

14. The method of claim 9, wherein the adding a microbial material comprises adding two or more different microbial materials.

15. The method of claim 9, further comprising adding an activator to the base material.

16. The method of claim 15, wherein the activator is a viscous liquid mineral.

17. The method of claim 9, further comprising adding a mineral to the base material.

18. The method of claim 17, wherein the mineral is selected from the group consisting of hydrogen, boron, silicon dioxide, carbon, nickel, cobalt, and copper.

19. The method of claim 9, further comprising:
adding an activator and at least one material into the base material,
wherein the soil amendment comprises between 90-98% base material, between 1-3% activator, between 1-5% microbial material, and between 1-3% mineral.

20. A method of using the soil amendment of claim 1 includes adding the soil amendment to a soil.
